(19) United States
(12) Patent Application Publication
(10) Pub. No.: US 2024/0120520 A1
(43) Pub. Date: Apr. 11, 2024

(54) FUEL BATTERY CELL AND MANUFACTURING METHOD THEREFOR

(71) Applicant: HITACHI HIGH-TECH CORPORATION, Tokyo (JP)

(72) Inventors: Yoshitaka SASAGO, Tokyo (JP); Noriyuki SAKUMA, Tokyo (JP); Natsuki YOKOYAMA, Tokyo (JP); Koji FUJISAKI, Tokyo (JP); Nobuyuki MISE, Tokyo (JP); Aritoshi SUGIMOTO, Tokyo (JP)

(21) Appl. No.: 18/275,884

(22) PCT Filed: Mar. 31, 2021
(86) PCT No.: PCT/JP2021/013769

§ 371 Date: Aug. 4, 2023

(51) Int. Cl. H01M 8/1226; H01M 8/1246

(52) U.S. Cl. CPC H01M 8/1226; H01M 8/1246; H01M 2008/1293

(57) ABSTRACT

A decrease in output power due to a foreign matter present on a base at the time of forming a thin film solid electrolyte layer is limited, and an increase in yield even when an area of a fuel battery cell is increased, is obtained. The fuel battery cell has a membrane electrode assembly including a lower electrode layer, first and second solid electrolyte layers, and an upper electrode layer formed on a support substrate. An interface between the first and second solid electrolyte layers is flat as compared with an interface between the lower electrode layer and the solid electrolyte layer, and the second solid electrolyte layer has a thickness at which a leakage current between the first solid electrolyte layer and the second solid electrolyte layer is less than an allowable value even when an output voltage of the fuel battery cell is generated.

### TECHNICAL FIELD

The present invention relates to a solid oxide fuel cell in which a solid electrolyte layer is formed by a film formation process.

### BACKGROUND ART

Background techniques within the technical field relating to the invention include JP2016-115506A (PTL 1) and Journal of Power Sources 194 (2009), pages 119-129 (NPL 1).

NPL 1 describes a cell technique of forming an anode layer, a solid electrolyte layer, and a cathode layer of a fuel cell membrane by a thin film formation process. By reducing a thickness of a solid electrolyte, ion conductivity can be increased and power generation efficiency can be improved. The ion conductivity of the solid electrolyte shows temperature dependence in an activated form. Therefore, the ion conductivity is high at a high temperature and is low at a low temperature. By reducing the thickness of the solid electrolyte, the ion conductivity can be sufficiently high even at a low temperature, and the power generation efficiency can be achieved for a practical use. An yttria stabilized zirconia (YSZ), which is zirconia doped with yttria or the like, is often used as the solid electrolyte layer. This is because the YSZ is advantageous in that chemical stability is excellent and a current due to electrons and holes causing an internal leakage current of the fuel cell is small. By using porous electrodes as an anode layer and a cathode layer, it is possible to increase a triple phase boundary at which a gas, an electrode, and the solid electrolyte are in contact with each other, and it is possible to limit power loss due to polarization resistance generated at an electrode interface.

Although the output power per area can be increased by reducing the thickness of the solid electrolyte layer, the leakage current in the solid electrolyte layer between the anode layer and a cathode due to the reduction in the thickness becomes a problem. When a uniform solid electrolyte layer can be formed, for example, when the YSZ is used for the solid electrolyte layer, the thickness can be reduced to 100 nanometers or less. In fact, in many cases, the leakage current is increased between the anode layer and the cathode as a result of an extremely thin portion of the solid electrolyte layer being formed due to a foreign matter present on a base before the formation of the solid electrolyte layer.

In a case of a fuel battery cell manufactured using a green sheet as disclosed in PTL 1, a solid electrolyte layer having a thickness of several tens of micrometers is used. However, in a fuel battery cell in which a solid electrolyte layer is formed by thin film formation, a thickness of the solid electrolyte layer is reduced to 1 micrometer or less. For this reason, it is essential to limit an influence of the foreign matter.

Although it is not used as a countermeasure against the foreign matter present on the base before the solid electrolyte layer is formed, NPL 2 discloses a technique of filling a void formed in a solid electrolyte layer. The void formed in the solid electrolyte layer (YSZ layer) formed on an anode layer is filled by forming an alumina film by atomic layer deposition (ALD), then a part of alumina is removed by etch back, and subsequently the solid electrolyte layer (YSZ layer) is additionally formed.

### CITATION LIST

### Patent Literature

PTL 1: JP2016-115506A

### Non Patent Literature

NPL 1: Journal of Power Sources 194 (2009), pages 119-129
NPL 2: Adv. Funct. Mater. 21(2011), pages 1154-1159

### SUMMARY OF INVENTION

### Technical Problem

Although the void formed in the solid electrolyte can be filled according to the method described in NPL2, the influence of the foreign matter present on the base before the formation of the solid electrolyte layer cannot be limited. Since the electrodes need to diffuse a gas in the fuel battery cell, it is necessary to form the electrodes to be porous. Therefore, when the solid electrolyte layer is formed, the solid electrolyte layer is formed on the porous electrodes. Since the porous electrodes have a structure in which an electrode material in a particulate form is gathered, a frequency of foreign matter occurrence at the time of formation is very high as compared with a flat and dense electrode. When a foreign matter having a size that cannot be ignored as compared with the thickness of the solid electrolyte layer is present on the porous electrodes serving as the base, the thickness of the solid electrolyte layer is formed to be extremely thin in a foreign matter portion, and a hole is formed in the solid electrolyte layer in an extreme case. As a result, during an operation of the fuel battery cell, leakage due to an electron current and a hole current occurs between the anode layer and the cathode via the thin solid electrolyte layer of the foreign matter portion, and thereby decreasing the output power of the fuel battery cell. In addition, when a hole is formed in the solid electrolyte layer, a fuel gas to be supplied to an anode side and an oxidant gas to be supplied to a cathode side are diffused to each other through the hole of the solid electrolyte layer, and the output power of the fuel battery cell is also decreased.

The invention has been made in view of the above problems, and an object of the invention is to limit a decrease in output power due to a foreign matter present on a base at the time of forming a thin film solid electrolyte layer, increase a yield when an area of a fuel battery cell is increased, and reduce the cost of a fuel cell.

### Solution to Problem

In a fuel battery cell according to the invention, a membrane electrode assembly including a lower electrode layer, a first solid electrolyte layer, a second solid electrolyte layer, and an upper electrode layer is formed on a support substrate, an interface between the first solid electrolyte layer and the second solid electrolyte layer is flat as compared with an interface between the lower electrode layer and the solid electrolyte layer, and the second solid electrolyte layer has a thickness at which a leakage current between the first solid electrolyte layer and the second solid electrolyte layer is less than an allowable value even when an output voltage of the fuel cell is generated.

### Advantageous Effects of Invention

According to the fuel battery cell of the invention, it is possible to provide a solid oxide fuel cell that has large output power per area, can be formed in a large area, and can be operated at a low temperature. Problems, configurations, and effects other than those described above will become clear from the following description of embodiments.

### BRIEF DESCRIPTION OF DRAWINGS

FIG. 1 is a diagram illustrating a general structure of a fuel battery cell that includes a solid electrolyte layer having a reduced thickness.

FIG. 2 is a schematic diagram illustrating a configuration example of a fuel cell module using a thin film process type SOFC according to Embodiment 1.

FIG. 3 is a view of a shielding plate seen from a fuel cell side.

FIG. 4 is a view of fuel battery cells seen from a lower side of the shielding plate.

FIG. 5 is a schematic diagram illustrating a configuration example of a fuel battery cell 1 according to Embodiment 1.

FIG. 6 is a diagram illustrating an example of a method for forming the fuel battery cell 1 illustrated in FIG. 5.

FIG. 7 is a diagram illustrating the example of the method for forming the fuel battery cell 1 illustrated in FIG. 5.

FIG. 8 is a diagram illustrating the example of the method for forming the fuel battery cell 1 illustrated in FIG. 5.

FIG. 9 is a diagram illustrating the example of the method for forming the fuel battery cell 1 illustrated in FIG. 5.

FIG. 10 is a diagram illustrating the example of the method for forming the fuel battery cell 1 illustrated in FIG. 5.

FIG. 11 is a diagram illustrating the example of the method for forming the fuel battery cell 1 illustrated in FIG. 5.

FIG. 12 is a diagram illustrating the example of the method for forming the fuel battery cell 1 illustrated in FIG. 5.

FIG. 13 illustrates a difference in shape between a fuel battery cell according to the related art and the fuel battery cell 1 according to Embodiment 1 at a portion where a foreign matter 200 on a lower electrode layer 20 is present.

FIG. 14 is a diagram illustrating a leakage current of the fuel battery cell 1 according to Embodiment 1.

FIG. 15 illustrates a manufacturing method according to a modification using a first porous metal substrate 71 as a substrate of the fuel battery cell 1.

FIG. 16 illustrates the manufacturing method according to the modification using the first porous metal substrate 71 as the substrate of the fuel battery cell 1.

FIG. 17 illustrates the manufacturing method according to the modification using the first porous metal substrate 71 as the substrate of the fuel battery cell 1.

FIG. 18 illustrates the manufacturing method according to the modification using the first porous metal substrate 71 as the substrate of the fuel battery cell 1.

FIG. 19 illustrates the manufacturing method according to the modification using the first porous metal substrate 71 as the substrate of the fuel battery cell 1.

FIG. 20 illustrates an example of a manufacturing method for the fuel battery cell 1 according to Embodiment 2.

FIG. 21 illustrates the example of the manufacturing method for the fuel battery cell 1 according to Embodiment 2.

FIG. 22 illustrates the example of the manufacturing method for the fuel battery cell 1 according to Embodiment 2.

FIG. 23 illustrates an example of the manufacturing method for the fuel battery cell 1 according to Embodiment 2.

FIG. 24 illustrates the example of the manufacturing method for the fuel battery cell 1 according to Embodiment 2.

FIG. 25 illustrates the example of the manufacturing method for the fuel battery cell 1 according to Embodiment 2.

FIG. 26 illustrates the example of the manufacturing method for the fuel battery cell 1 according to Embodiment 2.

FIG. 27 illustrates a shape of the fuel battery cell 1 according to Embodiment 2 at portions where the foreign matters 200 on the lower electrode layer 20 and an upper electrode layer 10 are present.

FIG. 28 illustrates a modification of Embodiment 2.

### DESCRIPTION OF EMBODIMENTS

Hereinafter, embodiments will be described in detail with reference to the drawings. In all the drawings with reference to which the embodiments will be described, members having the same function are denoted by the same or related reference numerals, and repetitive descriptions thereof are omitted. In addition, when there are similar members (portions), a generic reference numeral of the members may be added with a symbol to denote an individual or specific portion. In the following description of the embodiments, a description of the same or similar portions is not repeated in principle unless otherwise particularly necessary.

In the following embodiments, an X direction, a Y direction, and a Z direction are used as directions for description. The X direction and the Y direction are directions that are orthogonal to each other and constitute a horizontal plane, and the Z direction is a direction perpendicular to the horizontal plane.

In the drawings used in the embodiments, hatching may be omitted even in a cross-sectional view in order to make the drawings easy to see. In addition, the hatching may be added even in a plan view in order to make the drawings easy to see.

In the cross-sectional view and the plan view, sizes of respective parts do not correspond to those of an actual device, and a specific portion may be displayed in a relatively large size in order to make the drawings easy to understand. Even in a case where the cross-sectional view and the plan view correspond to each other, a specific portion may be displayed in a relatively large size in order to make the drawings easy to understand.

### <Increase of Output Power per Projected Area to Substrate by Thin Film Process Type Fuel Cell and Decrease in Operating Temperature>

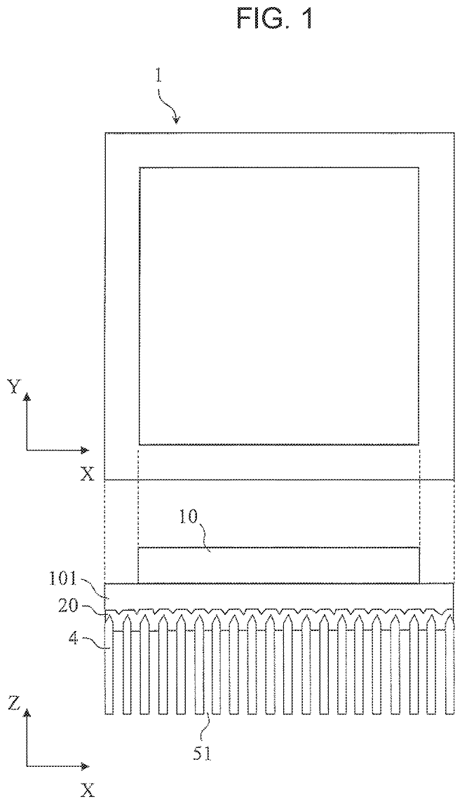

FIG. 1 is a diagram illustrating a general structure of a fuel battery cell that includes a solid electrolyte layer having a reduced thickness. In order to increase power generation efficiency and achieve a low-temperature operation, it is necessary to reduce a thickness of a solid electrolyte layer that constitutes a membrane electrode assembly for a fuel cell, and a thin film process type fuel cell in which a solid electrolyte layer is formed by a film formation process is most suitable. When an anode electrode layer, the solid electrolyte layer, and a cathode electrode layer are all reduced in thickness, a mechanical strength of the membrane electrode assembly for a fuel cell is weakened, but can be compensated for by support provided by a substrate as illustrated in FIG. 1. For example, an anodized alumina substrate (AAO substrate) 4 can be used as the substrate as illustrated in FIG. 1. In FIG. 1, a first solid electrolyte layer 101 is formed on a lower electrode layer 20 formed on the first AAO substrate 4, and an upper electrode layer 10 is formed thereon. The first AAO substrate 4 can supply a fuel gas or an oxidant gas from a lower surface to the lower electrode layer 20 via first pores 51. The upper electrode layer 10 and the lower electrode layer 20 can be formed to be porous.

### Embodiment 1: Configuration of Fuel Cell

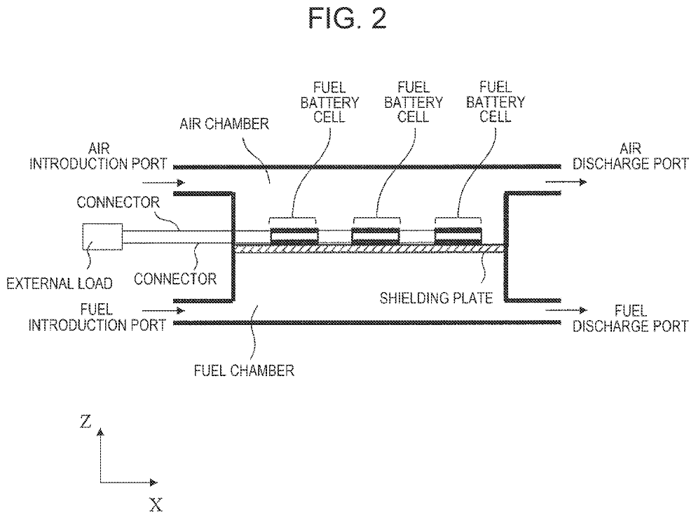

FIG. 2 is a schematic diagram illustrating a configuration example of a fuel cell module using a thin film process type solid oxide fuel cell (SOFC) according to Embodiment 1 of the invention. A gas flow path in the module is separated into a flow path for the fuel gas and a flow path for a gas containing oxygen gas (for example, air, the same applies hereinafter). The flow path for the fuel gas includes a fuel introduction port, a fuel chamber, and a fuel discharge port. The flow path for air includes an air introduction port, an air chamber, and an air discharge port. The fuel gas and the air are shielded by a shielding plate in FIG. 2 so as not to be mixed in the module. Wirings are extended from anode electrodes and cathode electrodes of the fuel battery cells by connectors, and are connected to an external load.

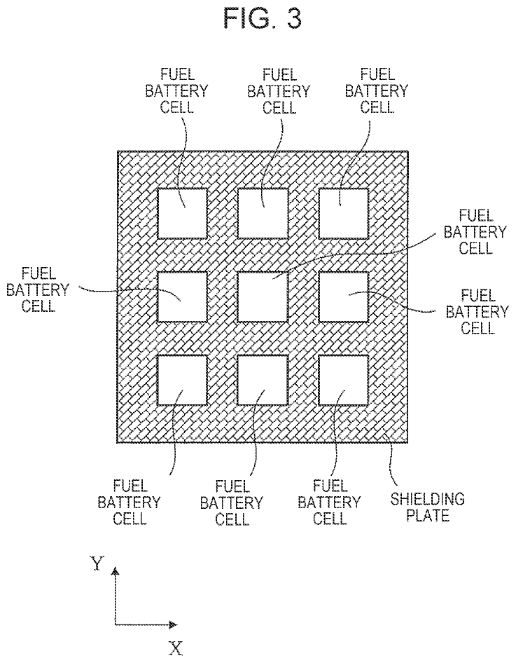

FIG. 3 is a view of the shielding plate seen from a fuel cell side. The fuel battery cells are mounted on the shielding plate. The number of the fuel battery cells may be one, but a plurality of fuel battery cells are generally arranged.

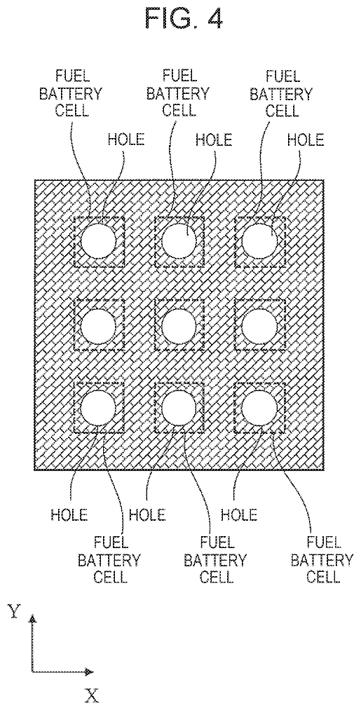

FIG. 4 is a view of the fuel battery cells seen from a lower side of the shielding plate. With respect to each of the fuel battery cells, a hole is formed in the shielding plate, and the fuel gas is supplied from the fuel chamber to the fuel battery cells.

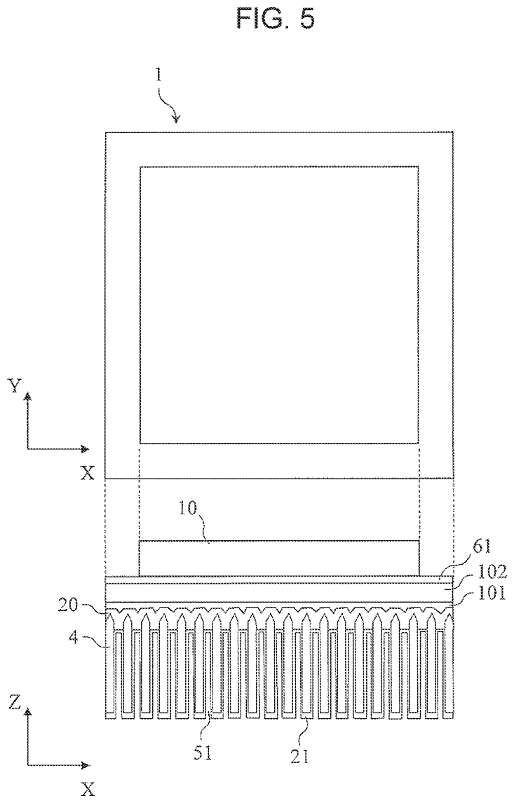

FIG. 5 is a schematic diagram illustrating a configuration example of a fuel battery cell 1 according to Embodiment 1. The fuel battery cell 1 corresponds to the fuel battery cells illustrated in FIGS. 2 to 4. The lower electrode layer 20 is formed on the first AAO substrate 4. The first pores 51 are formed in the first AAO substrate 4, and the fuel gas or the oxidant gas can be supplied from the lower surface to the lower electrode layer 20 via the first pores 51. The lower electrode layer 20 can be formed of platinum, a cermet material made of platinum and a metal oxide, nickel, a cermet material made of nickel and a metal oxide, or the like. The lower electrode layer 20 can be supplied with power from the lower surface of the first AAO substrate 4 via a lower electrode wiring layer 21 formed on side walls of the first pores 51. The lower electrode wiring layer 21 can be formed of platinum, nickel, or the like. The lower electrode layer 20 and the lower electrode wiring layer 21 can be formed of a porous material.

A zirconia thin film doped with yttria serving as the first solid electrolyte layer 101 is formed on an upper layer of the lower electrode layer 20. A doping amount of yttria can be, for example, 3% or 8%. The first solid electrolyte layer 101 is formed to completely cover the lower electrode layer 20 on the first AAO substrate. A thickness of the first solid electrolyte layer 101 can be equal to or larger than unevenness (D) of a predetermined region on a surface of the lower electrode layer 20 serving as a base, and can be equal to or less than twice (2×D) thereof. For example, when D is 100 nm, the thickness is set to 100 nm or more and 200 nm or less. An upper surface of the first solid electrolyte layer 101 can be flattened as compared with the surface of the lower electrode layer 20. As will be described later, it can be achieved by using chemical mechanical polishing (CMP) after the first solid electrolyte layer 101 is formed. Here, the unevenness (D) can be defined as a total of a maximum peak height and a maximum valley depth in the predetermined region on the surface, for example.

A zirconia thin film doped with yttria serving as a second solid electrolyte layer 102 is formed on an upper layer of the first solid electrolyte layer 101. A doping amount of yttria can be, for example, 3% or 8%. The same material as that of the first solid electrolyte layer 101 can be used as a material of the second solid electrolyte layer 102. The second solid electrolyte layer 102 is formed to completely cover the first solid electrolyte layer 101. A thickness of the second solid electrolyte layer 102 is set to a thickness at which a current due to electron leakage and hole leakage between an anode layer and a cathode layer can be sufficiently limited by only the second solid electrolyte layer 102. The YSZ has an extremely small amount of an electron current and a hole current serving as an internal leakage current of the fuel battery cell 1 at a high temperature, and thus the thickness of the second solid electrolyte layer 102 can be reduced to 100 nm or less. By sufficiently reducing the unevenness (D) of the lower electrode layer 20, a total thickness of the first solid electrolyte layer 101 and the second solid electrolyte layer 102 can be set to 1000 nm or less.

A first interface layer 61 is formed on an upper layer of the second solid electrolyte layer 102. The first interface layer 61 can be formed of ceria (CeO2) doped with 10% of gadolinia (Gd2O3), for example. The first interface layer 61 is formed to cover an upper surface of the second solid electrolyte layer 102. The first interface layer 61 is used in a case where the second solid electrolyte layer 102 and the upper electrode layer 10 are likely to chemically react with each other due to heat load during a manufacturing process and an operation of the fuel battery cell 1, and it is not preferable to bring the second solid electrolyte layer 102 and the upper electrode layer 10 into direct contact with each other. By forming the first interface layer 61 between the upper electrode layer 10 and the second solid electrolyte layer 102, an effect of reducing polarization resistance in the upper electrode layer 10 during the operation may be obtained. Depending on a use condition such as an operating temperature of the fuel battery cell 1, the first interface layer 61 may be not formed. As will be described later, it is also possible to separately form an interface layer at an interface between the lower electrode layer 20 and the first solid electrolyte layer 101.

The upper electrode layer 10 is formed on an upper layer of the first interface layer 61. The upper electrode layer 10 can be formed of, for example, porous platinum or a cermet material made of platinum and a metal oxide. The upper electrode layer 10 is formed to cover a part of the first AAO substrate 4.

As described above, the thin film process type fuel battery cell 1 is provided with a membrane electrode assembly including the first AAO substrate 4, the lower electrode wiring layer 21, the lower electrode layer 20, the first solid electrolyte layer 101, the second solid electrolyte layer 102, the first interface layer 61, and the upper electrode layer 10 from a lower layer.

For example, a fuel gas containing hydrogen is supplied to a lower electrode layer 20 side, and for example, an oxidant gas such as air is supplied to an upper electrode layer 10 side. The supplied fuel gas reaches the lower electrode layer 20 through the first pores 51 of the first AAO substrate 4. The supplied oxidant gas is supplied to a surface of the upper electrode layer 10. The oxidant gas and the fuel gas react with each other by ion conduction via the first solid electrolyte layer 101, the second solid electrolyte layer 102, and the first interface layer 61, so that the fuel battery cell 1 can operate in the same manner as a known fuel cell. The lower electrode layer 20 side and the upper electrode layer 10 side are sealed so that the supplied oxidant gas and the supplied fuel gas do not mix with each other in a gas state.

The supply of the fuel gas and the oxidant gas is contrary to the above case, it is also possible to supply, for example, an oxidant gas such as air to the lower electrode layer 20 side and supply, for example, a fuel gas containing hydrogen to the upper electrode layer 10 side. In this case as well, the lower electrode layer 20 side and the upper electrode layer 10 side are sealed so that the supplied oxidant gas and the supplied fuel gas do not mix with each other in a gas state.

### Embodiment 1: Manufacturing Method

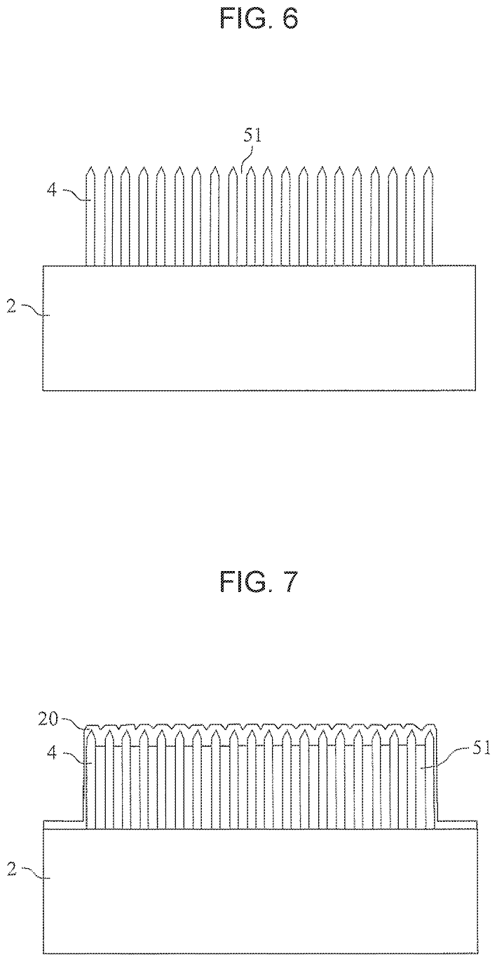

FIGS. 6 to 12 are diagrams illustrating an example of a method for forming the fuel battery cell 1 illustrated in FIG. 5. First, the first AAO substrate 4 is formed on a silicon substrate 2 (FIG. 6). A plurality of the first pores 51 penetrating between the upper and lower surfaces are formed in the first AAO substrate 4. A diameter of the first pores 51 can be set to, for example, 50 nm to 100 nm.

Next, the lower electrode layer 20 is formed on the first AAO substrate 4 (FIG. 7). For example, the lower electrode layer 20 can be formed by a sputtering method using a cermet made of nickel and the YSZ, and a thickness thereof can be set to 100 nm to 200 nm. Since an upper surface of the first AAO substrate 4 has an uneven shape and the lower electrode layer 20 is formed to be porous, the upper surface of the lower electrode layer 20 has an uneven shape. In addition, a frequency of a foreign matter occurring and adhering to the surface of the lower electrode layer 20 when the porous lower electrode layer 20 is formed is extremely high. The foreign matter occurring in a film formation process of the lower electrode layer 20 is conductive, and as will be described later, in the fuel battery cell according to the related art, the electron leakage and the hole leakage between the anode layer and the cathode layer are caused, and the output voltage of the fuel battery cell is decreased, and thus a countermeasure is required. As illustrated in FIG. 7, the lower electrode layer 20 is also formed on a side surface of the first AAO substrate 4 and an upper surface of the silicon substrate 2 in addition to the upper surface of the first AAO substrate 4. The silicon substrate 2 can be replaced with a substrate using another material as long as the substrate has sufficient strength, surface flatness, and ease of processing.

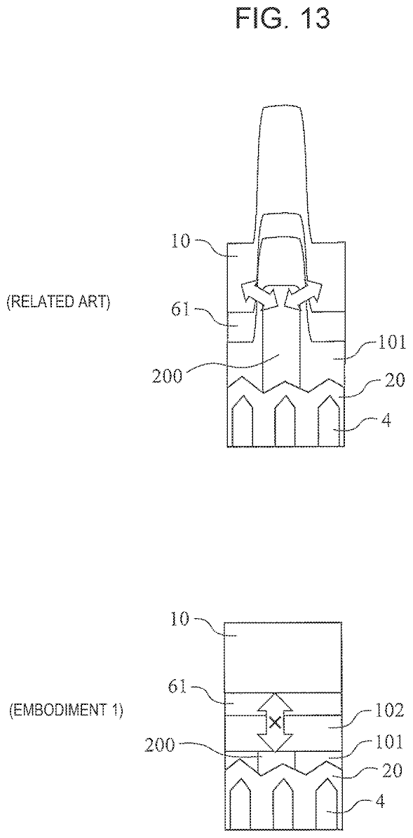

Next, the first solid electrolyte layer 101 is formed on the upper surface of the lower electrode layer 20 (FIG. 8). Regarding a material of the first solid electrolyte layer 101, the doping amount of yttria can be, for example, 3% or 8%. Since the solid electrolyte layer has a function of preventing mixing of gases on an anode side and a cathode side, the solid electrolyte layer is densely formed. For example, the dense first solid electrolyte layer 101 can be formed by a sputtering method using an oxide target or a reactive sputtering method using a metal target. Since the upper surface of the lower electrode layer 20 has an uneven shape, the upper surface of the first solid electrolyte layer 101 has an uneven shape. When the foreign matter is formed on the lower electrode layer 20 described above, the first solid electrolyte layer 101 does not have a desired thickness at a foreign matter portion. A shape of the foreign matter portion will be described later (FIG. 13). As illustrated in FIG. 8, the first solid electrolyte layer 101 is also formed on the side surface of the first AAO substrate 4 and the upper surface of the silicon substrate 2 in addition to the upper surface of the first AAO substrate 4.

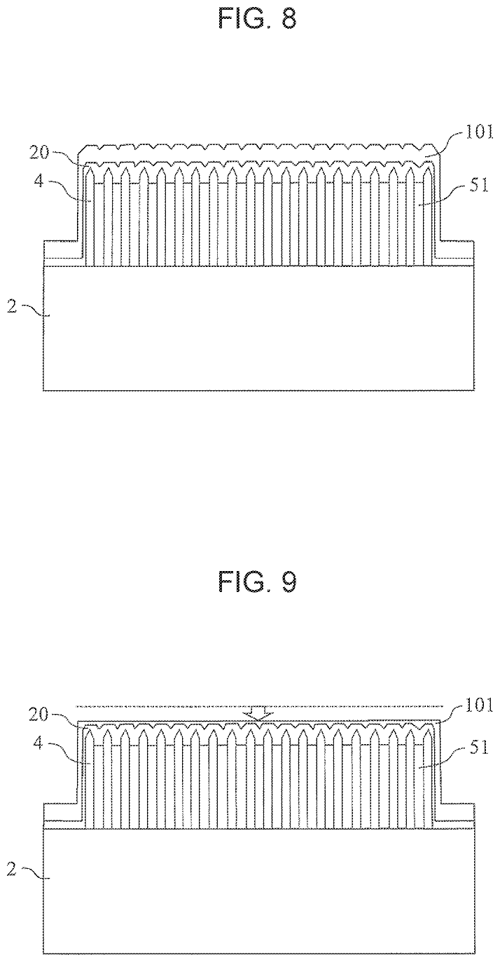

Next, a part of the surface of the first solid electrolyte layer 101 is removed by chemical mechanical polishing (CMP) (FIG. 9). In this case, in order to prevent such a case where the first solid electrolyte layer 101 is completely removed and the lower electrode layer 20 is exposed, or a residual thickness of the first solid electrolyte layer 101 is too thick and the output voltage of the fuel battery cell 1 is extremely decreased, the residual thickness of the first solid electrolyte layer 101 is set to be equal to or larger than the unevenness (D) of the predetermined region on the surface of the lower electrode layer 20 serving as a base, and is set to be equal to or less than twice (2×D) thereof. For example, when D is 100 nm, the thickness is set to 100 nm or more and 200 nm or less. When CMP is used, a part of the first solid electrolyte layer 101 on the upper surface of the first AAO substrate 4 is removed, but the first solid electrolyte layer 101 formed on the silicon substrate 2 having a low height is not removed and has a residual thickness for forming a layer. When the foreign matter described above is present on the lower electrode layer 20 on the first AAO substrate 4, the foreign matter is polished simultaneously with the first solid electrolyte layer 101 in a polishing process by the CMP, and thus the surface is also flattened at the foreign matter portion. The shape of the foreign matter portion will be described later (FIG. 13). A part of the first solid electrolyte layer 101 is removed on the upper surface of the first AAO substrate 4 as illustrated in FIG. 9, but is not removed on the side surface of the first AAO substrate 4 and the upper surface of the silicon substrate 2.

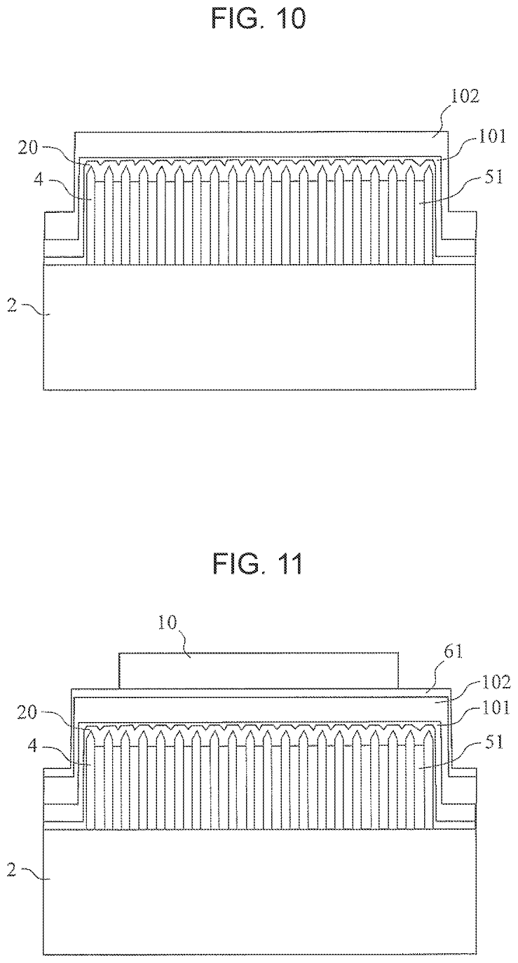

Next, the second solid electrolyte layer 102 is formed on the upper surface of the first solid electrolyte layer 101 (FIG. 10). Regarding a material of the second solid electrolyte layer 102, the doping amount of yttria can be, for example, 3% or 8%. The same composition as that of the first solid electrolyte layer 101 can be used as the second solid electrolyte layer 102. Since the solid electrolyte layer has a function of preventing the mixing of the gases on the anode side and the cathode side, the solid electrolyte layer is densely formed. For example, the dense second solid electrolyte layer 102 can be formed by a sputtering method using an oxide target or a reactive sputtering method using a metal target. Since the surface of the first solid electrolyte layer 101 is flattened in an upper surface region of the first AAO substrate 4, the second solid electrolyte layer 102 can be formed with a uniform thickness. Strictly speaking, although some unevenness remains on the surface of the first solid electrolyte layer 101 even after the polishing by CMP, unevenness due to an influence of the uneven shape of the lower electrode layer 20 is eliminated. Therefore, in-plane distribution of the second solid electrolyte layer 102 is not affected by local unevenness of the lower electrode layer 20. Similarly, the second solid electrolyte layer 102 can be formed with a uniform thickness at the foreign matter portion described above as well. The thickness of the second solid electrolyte layer 102 can be, for example, 100 nm. The shape of the foreign matter portion will be described later (FIG. 13). As illustrated in FIG. 10, the second solid electrolyte layer 102 is also formed on the side surface of the first AAO substrate 4 and the upper surface of the silicon substrate 2 in addition to the upper surface of the first AAO substrate 4.

Although the thickness of the second solid electrolyte layer 102 is uniform, the thickness of the entire second solid electrolyte layer 102 is not necessarily exactly the same. At least a difference between a maximum thickness and a minimum thickness of the second solid electrolyte layer 102 is smaller than the unevenness (D) of the lower electrode layer 20. Accordingly, the second solid electrolyte layer 102 can be formed to be flatter than the lower electrode layer 20. The same applies to a case where the second solid electrolyte layer 102 is formed to be flat in the following embodiments.

Next, the first interface layer 61 is formed on the upper surface of the second solid electrolyte layer 102 (FIG. 11). The first interface layer 61 can be formed of ceria (CeO2) doped with 10% of gadolinia (Gd2O3), for example. The first interface layer 61 is formed to cover the upper surface of the second solid electrolyte layer 102. Since the surface of the second solid electrolyte layer 102 is flat in the upper surface region of the first AAO substrate 4, the first interface layer 61 can be formed with a uniform thickness. The first interface layer 61 is also formed on the side surface of the first AAO substrate 4 and the upper surface of the silicon substrate 2 in addition to the upper surface of the first AAO substrate 4. Next, the upper electrode layer 10 is formed on the upper surface of the first interface layer 61 (FIG. 11). The upper electrode layer 10 is formed on a part of the upper surface of the first AAO substrate 4. The upper electrode layer 10 can be formed of, for example, porous platinum or a cermet material made of platinum and a metal oxide.

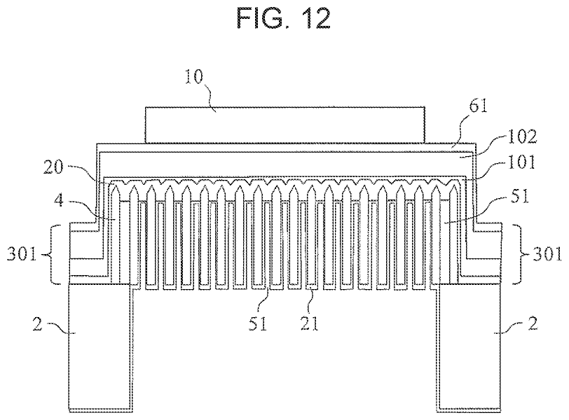

Next, after a part of the silicon substrate 2 in a region where the first AAO substrate 4 is formed is removed from a lower surface side, the lower electrode wiring layer 21 is formed on inner walls of the first pores 51 by ALD to complete the fuel battery cell 1 (FIG. 12). The lower electrode wiring layer 21 can be formed of, for example, platinum or nickel. The lower electrode layer 20 and the lower electrode wiring layer 21 can be formed of a porous material. A lower surface side of the first AAO substrate 4 and the lower electrode layer 20 can be electrically connected via the lower electrode wiring layer 21. The lower electrode wiring layer 21 is formed on side walls of the first pores 51, and does not completely fill the first pores 51. Therefore, the fuel gas or the oxidant gas supplied from the lower surface side of the first AAO substrate 4 can reach the lower electrode layer 20 via the first pores 51. As illustrated in FIG. 12, the lower electrode layer 20, the first solid electrolyte layer 101, the second solid electrolyte layer 102, the first interface layer 61, and the upper electrode layer 10 are formed on first fuel battery cell end portions 301. The first solid electrolyte layer 101 on the first fuel battery cell end portions 301 is not removed in a CMP process of FIG. 9, and thus this first solid electrolyte layer 101 is formed to be thicker than the first solid electrolyte layer 101 in the upper surface region of the first AAO substrate 4.

### Embodiment 1: Effects

FIG. 13 illustrates a difference in shape between the fuel battery cell according to the related art and the fuel battery cell 1 according to Embodiment 1 at the portion on the lower electrode layer 20 where the foreign matter 200 is present. As illustrated in an upper part of FIG. 13, in the fuel battery cell according to the related art that is not subjected to the CMP process, a region where the first solid electrolyte layer 101 and the first interface layer 61 become extremely thin is formed around the foreign matter 200. As described above, the foreign matter occurring in the film formation process of the lower electrode layer 20 is conductive. As a result, during an operation of the fuel battery cell 1, a leakage current due to an electron current and a hole current occurs between the anode layer and the cathode layer via the conductive foreign matter 200, and thereby decreasing the output voltage of the fuel battery cell 1. On the other hand, in the fuel battery cell 1 according to Embodiment 1, an upper portion of the foreign matter is also removed and flattened simultaneously with a part of an upper portion of the first solid electrolyte layer 101 in the CMP process of FIG. 9 at the portion where the foreign matter 200 is present, and thus the second solid electrolyte layer 102 is formed with a uniform thickness. If the thickness of the second solid electrolyte layer 102 is sufficient to limit the leakage current due to the electron current and the hole current, the output power does not decrease.

In other words, the second solid electrolyte layer 102 can be configured as follows. When the fuel battery cell 1 generates power, a potential difference between the lower electrode layer 20 and the upper electrode layer 10 becomes the output voltage of the fuel battery cell 1. Even when this potential difference occurs, a thickness at which the leakage current between the first solid electrolyte layer 101 and the second solid electrolyte layer 102 is less than an allowable value (the second solid electrolyte layer 102 blocks the leakage current) is secured at any location on the second solid electrolyte layer 102 (that is, a location where the thickness of the second solid electrolyte layer 102 is thinnest). A specific thickness may be appropriately determined in view of balance between a capability of blocking the leakage current and performance of the fuel battery cell 1.

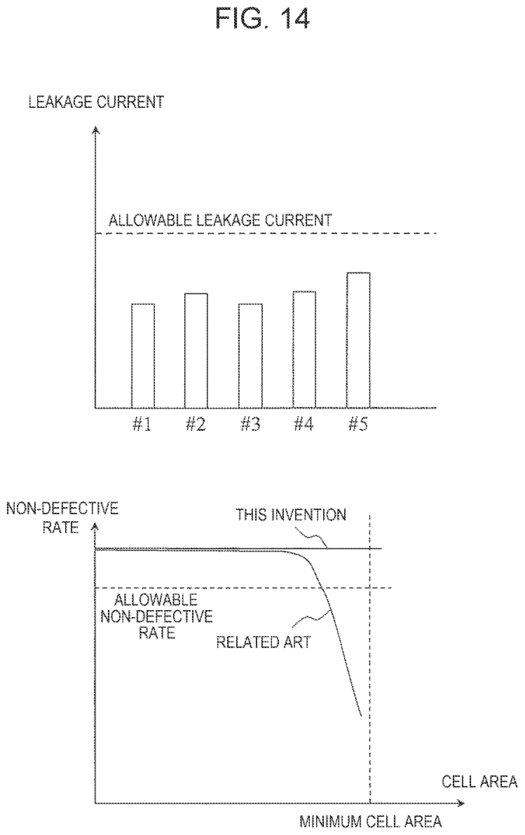

FIG. 14 is a diagram illustrating the leakage current of the fuel battery cell 1 according to Embodiment 1. An upper part of FIG. 14 illustrates leakage currents of samples #1 to #5 of the fuel battery cell 1 according to Embodiment 1. As an area of the fuel battery cell increases, a probability of including the foreign matter increases, and thus a defect due to the leakage currents is likely to occur. Cell areas of the samples #1 to #5 are larger than a minimum cell area that is allowed from the viewpoint of cost. As illustrated in the upper part of FIG. 14, it is possible to limit the leakage current to be equal to or less than the allowable value. It is considered that the leakage at the portion where the foreign matter 200 illustrated in a lower part of FIG. 13 is present can be limited. A lower part of FIG. 14 is a graph illustrating a relation between the cell area and a non-defective rate. Regarding the fuel battery cell according to the related art, the non-defective rate rapidly decreases with an increase in the area. Regarding a cell area larger than the minimum cell area that is allowed from the viewpoint of cost, an allowable non-defective rate cannot be maintained. It is considered that this is because a defective rate due to the leakage current at the portion of the foreign matter 200 illustrated in the upper part of FIG. 13 rapidly increases as the cell area increases. On the other hand, with respect to the fuel battery cell 1 according to Embodiment 1, a high non-defective rate can be secured even in the cell area larger than the minimum cell area that is allowed from the viewpoint of cost.

### Embodiment 1: Modification

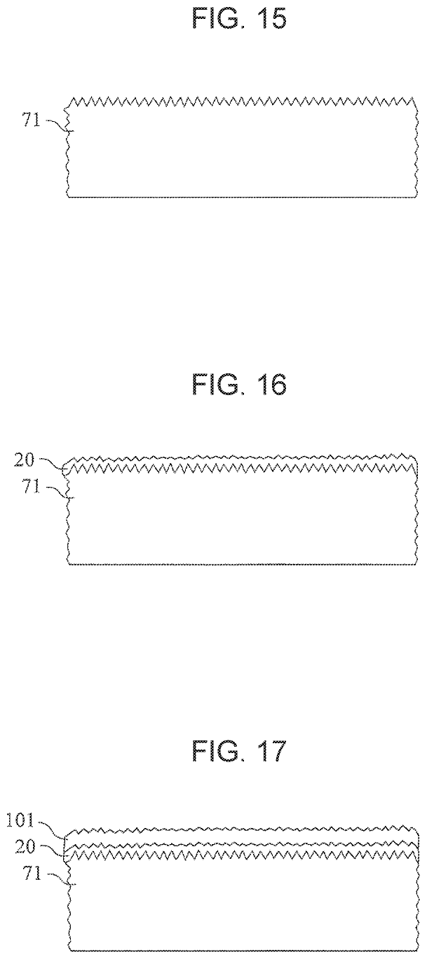

FIGS. 15 to 19 illustrate a manufacturing method according to a modification using a first porous metal substrate 71 as the substrate of the fuel battery cell 1. Although the structure and the manufacturing method for the fuel battery cell 1 using the first AAO substrate 4 are described in FIGS. 6 to 12, the first porous metal substrate 71 can also be used as the substrate of the fuel battery cell 1. The manufacturing method according to the modification of Embodiment 1 that uses the first porous metal substrate 71 as the substrate of the fuel battery cell 1 will be described with reference to FIGS. 15 to 19.

First, the first porous metal substrate 71 is prepared (FIG. 15). Since the first porous metal substrate 71 is porous, a surface thereof has an uneven shape. A ferritic stainless steel such as SUS can be used as a material of the first porous metal substrate 71. Next, the lower electrode layer 20 is formed on an upper surface of the first porous metal substrate 71 (FIG. 16). For example, the lower electrode layer 20 can be formed by a sputtering method using a cermet made of nickel and the YSZ, and a thickness thereof can be set to 100 nm to 200 nm. Since the upper surface of the first porous metal substrate 71 has an uneven shape and the lower electrode layer 20 is formed to be porous, the upper surface of the lower electrode layer 20 has an uneven shape. In addition, the frequency of the foreign matter occurring and adhering to the surface of the lower electrode layer 20 when the porous lower electrode layer 20 is formed is extremely high. The foreign matter occurring in the film formation process of the lower electrode layer 20 is conductive, and as will be described later, in the fuel battery cell according to the related art, the electron leakage and the hole leakage between the anode layer and the cathode layer are caused, and the output voltage of the fuel battery cell is decreased, and thus a countermeasure is required.

Next, the first solid electrolyte layer 101 is formed on the upper surface of the lower electrode layer 20 (FIG. 17). Regarding the material of the first solid electrolyte layer 101, the doping amount of yttria can be, for example, 3% or 8%. Since the solid electrolyte layer has a function of preventing the mixing of the gases on the anode side and the cathode side, the solid electrolyte layer is densely formed. For example, the dense first solid electrolyte layer 101 can be formed by a sputtering method using an oxide target or a reactive sputtering method using a metal target. Since the upper surface of the lower electrode layer 20 has an uneven shape, the upper surface of the first solid electrolyte layer 101 has an uneven shape. When the foreign matter is formed on the lower electrode layer 20, the first solid electrolyte layer 101 does not have a desired thickness at the foreign matter portion.

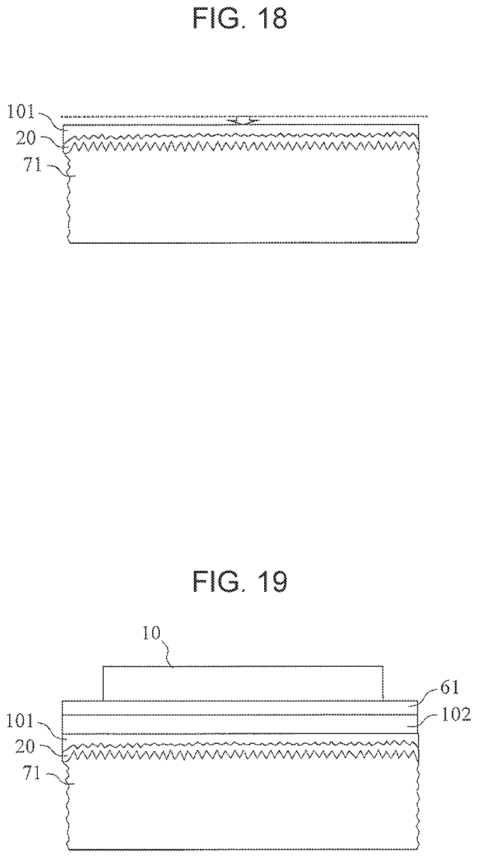

Next, a part of the surface of the first solid electrolyte layer 101 is removed by an appropriate method such as chemical mechanical polishing (CMP) (FIG. 18). In this case, in order to prevent such a case where the first solid electrolyte layer 101 is completely removed and the lower electrode layer 20 is exposed, or the residual thickness of the first solid electrolyte layer 101 is too thick and the output voltage of the fuel battery cell 1 is extremely decreased, the residual thickness of the first solid electrolyte layer 101 is set to be equal to or larger than the unevenness (D) of the predetermined region on the surface of the lower electrode layer 20 serving as a base, and is set to be equal to or less than twice (2×D) thereof. For example, when D is 100 nm, the residual thickness is set to 100 nm or more and 200 nm or less. When the foreign matter described above is present on the lower electrode layer 20 on the upper surface of the first porous metal substrate 71, the foreign matter is polished simultaneously with the first solid electrolyte layer 101 in the polishing process by CMP, and thus the surface is also flattened at the foreign matter portion.

Next, the second solid electrolyte layer 102 is formed on the upper surface of the first solid electrolyte layer 101 (FIG. 19). Regarding the material of the second solid electrolyte layer 102, the doping amount of yttria can be, for example, 3% or 8%. The same composition as that of the first solid electrolyte layer 101 can be used as the second solid electrolyte layer 102. Since the solid electrolyte layer has a function of preventing the mixing of the gases on the anode side and the cathode side, the solid electrolyte layer is densely formed. For example, the dense second solid electrolyte layer 102 can be formed by a sputtering method using an oxide target or a reactive sputtering method using a metal target. The thickness of the second solid electrolyte layer 102 can be, for example, 100 nm. Since the surface of the first solid electrolyte layer 101 is flattened in an upper surface region of the first porous metal substrate 71, the second solid electrolyte layer 102 can be formed with a uniform thickness. Strictly speaking, although some unevenness remains on the surface of the first solid electrolyte layer 101 even after the polishing by CMP, the unevenness due to the influence of the uneven shape of the lower electrode layer 20 is eliminated. Therefore, the in-plane distribution of the second solid electrolyte layer 102 is not affected by the local unevenness of the lower electrode layer 20. Similarly, the second solid electrolyte layer 102 can be formed with a uniform thickness at the foreign matter portion described above as well.

Next, the first interface layer 61 is formed on the upper surface of the second solid electrolyte layer 102. The first interface layer 61 can be formed of ceria (CeO2) doped with 10% of gadolinia (Gd2O3), for example. The first interface layer 61 is formed to cover the upper surface of the second solid electrolyte layer 102.

Next, the upper electrode layer 10 is formed on the upper surface of the first interface layer 61 to complete the fuel battery cell 1 (FIG. 19). The upper electrode layer 10 is formed on a part of the upper surface of the first porous metal substrate 71. The upper electrode layer 10 can be formed of, for example, porous platinum or a cermet material made of platinum and a metal oxide.

In the structure in FIG. 12, the first AAO substrate 4 is an insulator, and thus it is necessary to form the lower electrode wiring layer 21, whereas in the structure of the modification in FIG. 19, the first porous metal substrate 71 is formed of a conductive metal, and thus it is easy to supply power to the lower electrode layer 20. Since the first porous metal substrate 71 is porous, the fuel gas or the oxidant gas can be supplied to the lower electrode layer 20 from a lower surface of the first porous metal substrate 71.

In the present modification as well, the leakage current to be generated at the foreign matter portion on the upper surface of the lower electrode layer 20 can be limited, and a high non-defective rate can be secured even in the cell area larger than the minimum cell area that is allowed from the viewpoint of cost.

### Embodiment 2

In Embodiment 1, the second solid electrolyte layer 102 is formed after the upper surface of the first solid electrolyte layer 101 is flattened by CMP. However, the first solid electrolyte layer 101 on the lower electrode layer 20 and the second solid electrolyte layer 102 on the upper electrode layer 10 may be separately manufactured and then bonded.

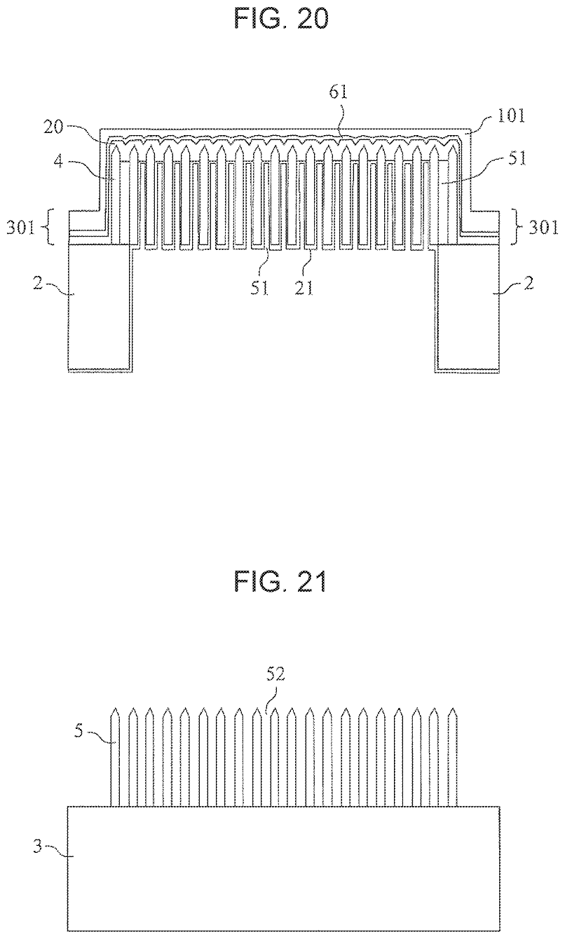

An example of a manufacturing method for the fuel battery cell 1 according to Embodiment 2 will be described with reference to FIGS. 20 to 26. FIG. 20 is a diagram in which a part of a lower surface of the silicon substrate 2 is removed and the lower electrode wiring layer 21 is formed in the process of FIG. 9 according to Embodiment 1. FIG. 20 is different from FIG. 9 in that the first interface layer 61 is formed at a boundary between the lower electrode layer 20 and the first solid electrolyte layer 101. Depending on the use condition such as an operating temperature of the fuel battery cell 1, the first interface layer 61 may be not formed. In Embodiment 1, the residual thickness of the first solid electrolyte layer 101 is set to be equal to or larger than the unevenness (D) of the predetermined region on the surface of the lower electrode layer 20 serving as a base, and is set to be equal to or less than twice (2×D) thereof. The residual thickness of the first solid electrolyte layer 101 in FIG. 20 is required to be equal to or larger than the unevenness (D) of the predetermined region on the surface of the lower electrode layer 20, and is required to be a thickness at which the leakage current is stopped by only the thickness of the first solid electrolyte layer 101. A thickness of a thinnest region may be 100 nm or more. Separately from FIG. 20, a second AAO substrate 5 is formed on a silicon substrate 3 as illustrated in FIG. 21. A plurality of second pores 52 penetrating between upper and lower surfaces are formed in the second AAO substrate 5. A diameter of the second pores 52 can be set to, for example, 50 nm to 100 nm. Next, the upper electrode layer 10 is formed on the second AAO substrate 5 (FIG. 22). The upper electrode layer 10 is formed on a part of the upper surface of the second AAO substrate 5. The upper electrode layer 10 can be formed of, for example, porous platinum or a cermet material made of platinum and a metal oxide. The upper electrode layer 10 can be formed by a sputtering method, and a thickness thereof can be set to 100 nm to 200 nm. Since an upper surface of the second AAO substrate 5 has an uneven shape and the upper electrode layer 10 is formed to be porous, the upper surface of the upper electrode layer 10 has an uneven shape. In addition, a frequency of the foreign matter occurring and adhering to the surface of the upper electrode layer 10 when the porous upper electrode layer 10 is formed is extremely high. The foreign matter occurring in a film formation process of the upper electrode layer 10 is conductive, and as will be described later, in the fuel battery cell according to the related art, the electron leakage and the hole leakage between the anode layer and the cathode layer are caused, and the output voltage of the fuel battery cell is decreased, and thus a countermeasure is required. As illustrated in FIG. 22, the upper electrode layer 10 is also formed on a side surface of the second AAO substrate 5 and an upper surface of the silicon substrate 3 in addition to the upper surface of the second AAO substrate 5. The silicon substrate 3 can be replaced with a substrate using another material as long as the substrate has sufficient strength, surface flatness, and ease of processing.

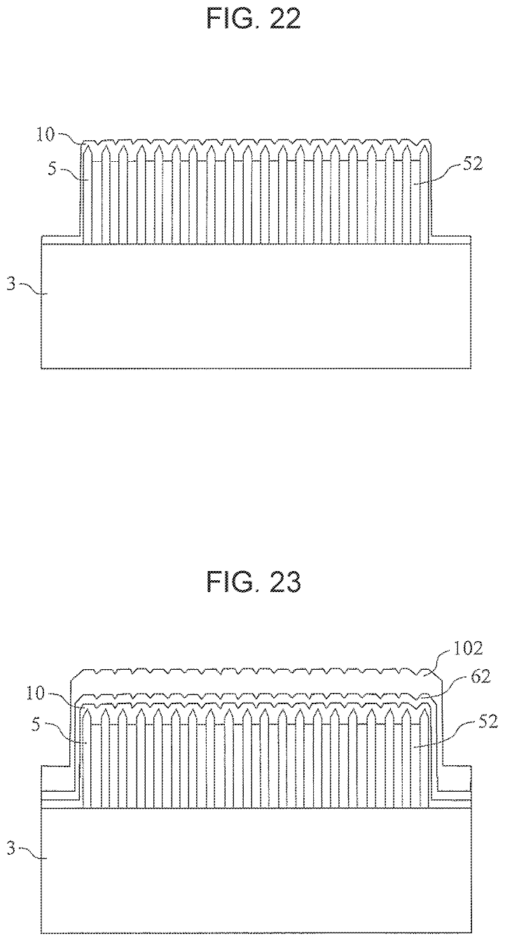

Next, a second interface layer 62 and the second solid electrolyte layer 102 are formed on the upper surface of the upper electrode layer 10 (FIG. 23). The second interface layer 62 can be formed of ceria (CeO2) doped with 10% of gadolinia (Gd2O3), for example. The second interface layer 62 is formed to cover the upper electrode layer 10. Regarding the material of the second solid electrolyte layer 102, the doping amount of yttria can be, for example, 3% or 8%. Since the solid electrolyte layer has a function of preventing the mixing of the gases on the anode side and the cathode side, the solid electrolyte layer is densely formed. For example, the dense second solid electrolyte layer 102 can be formed by a sputtering method using an oxide target or a reactive sputtering method using a metal target. Since the upper surface of the upper electrode layer 10 has an uneven shape, the upper surface of the second solid electrolyte layer 102 has an uneven shape. When the foreign matter is formed on the upper electrode layer 10 described above, the second solid electrolyte layer 102 does not have a desired thickness at the foreign matter portion. As illustrated in FIG. 23, the second interface layer 62 and the second solid electrolyte layer 102 are also formed on the side surface of the second AAO substrate 5 and the upper surface of the silicon substrate 3 in addition to the upper surface of the second AAO substrate 5.

Next, a part of the surface of the second solid electrolyte layer 102 is removed by an appropriate method such as chemical mechanical polishing (CMP) (FIG. 24). In this case, in order to prevent such a case where the second solid electrolyte layer is completely removed and the second interface layer 62 or the upper electrode layer 10 is exposed, the residual thickness of the second solid electrolyte layer 102 is set to be equal to or larger than unevenness (D) of a predetermined region on the surface of the upper electrode layer 10 serving as a base. Furthermore, the residual thickness is required to be a thickness at which the leakage current is stopped by only the thickness of the second solid electrolyte layer 102. A thickness of a thinnest region may be 100 nm or more. When CMP is used, a part of the second solid electrolyte layer 102 on the upper surface of the second AAO substrate 5 is removed, but the second solid electrolyte layer 102 formed on the silicon substrate 3 having a low height is not removed and has a residual thickness to form a layer. When the foreign matter described above is present on the upper electrode layer 10 on the second AAO substrate 5, the foreign matter is polished simultaneously with the second solid electrolyte layer 102 in the polishing process by CMP, and thus the surface is also flattened at the foreign matter portion. A part of the second solid electrolyte layer 102 is removed on the upper surface of the second AAO substrate 5 as illustrated in FIG. 24, but is not removed on the side surface of the second AAO substrate 5 and the upper surface of the silicon substrate 3.

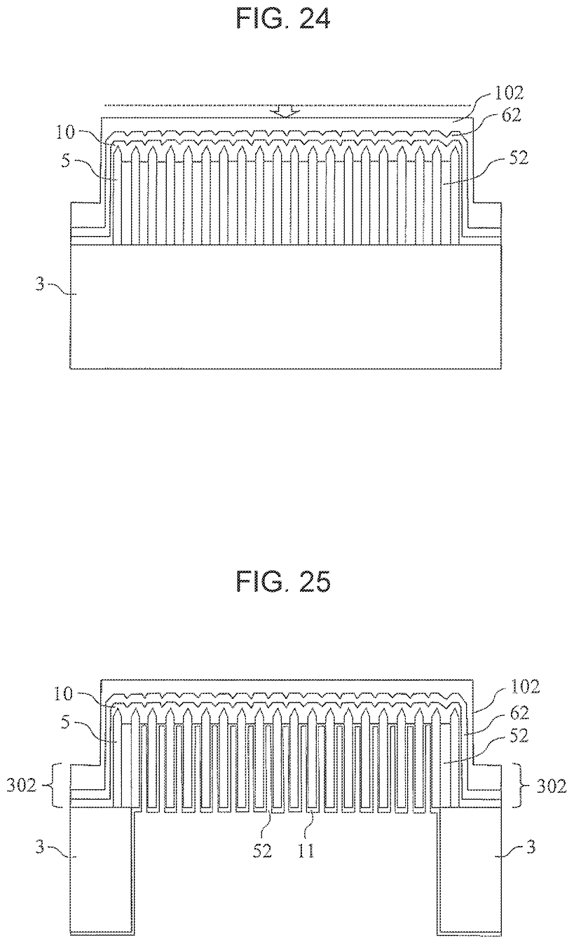

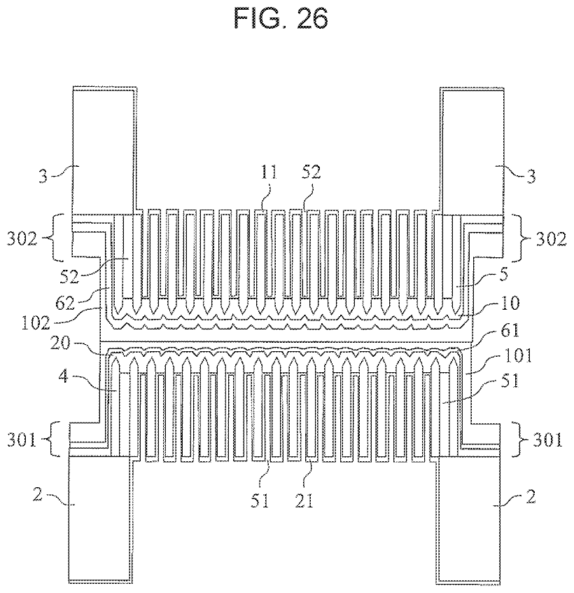

Next, after a part of the silicon substrate 3 in a region where the second AAO substrate 5 is formed is removed from a lower surface side, an upper electrode wiring layer 11 is formed on inner walls of the second pores 52 by ALD (FIG. 25). The upper electrode wiring layer 11 can be formed of, for example, platinum or nickel. A lower surface side of the second AAO substrate 5 and the upper electrode layer 10 can be electrically connected via the upper electrode wiring layer 11. The upper electrode wiring layer 11 is formed on side walls of the second pores 52, and does not completely fill the second pores 52. Therefore, the fuel gas or the oxidant gas supplied from the lower surface side of the second AAO substrate 5 can reach the upper electrode layer 10 via the second pores 52. As illustrated in FIG. 25, the upper electrode layer 10, the second interface layer 62, the second solid electrolyte layer 102 are formed on second fuel battery cell end portions 302. The second solid electrolyte layer 102 on the second fuel battery cell end portions 302 is not removed in the CMP process of FIG. 24, and thus this second solid electrolyte layer 102 is formed to be thicker than the second solid electrolyte layer 102 in an upper surface region of the second AAO substrate 5.

Next, the surface of the first solid electrolyte layer 101 in FIG. 20 and the surface of the second solid electrolyte layer 102 in FIG. 25 are bonded to complete the fuel battery cell 1 by being brought into contact with each other as illustrated in FIG. 26 and being fired. Since the second solid electrolyte layer 102 is formed by being flattened by CMP after being formed on the upper surface of the upper electrode layer 10, the thickness thereof is irrelevant to the unevenness of the surface of the upper electrode layer 10. Similarly, since the first solid electrolyte layer 101 is formed by being flattened by CMP after being formed on the upper surface of the lower electrode layer 20, the thickness thereof is irrelevant to the unevenness of the surface of the lower electrode layer 20.

Heat load due to a firing temperature is applied to parts of the fuel battery cell 1. The heat load applied to the lower electrode wiring layer 21 and the upper electrode wiring layer 11 can be avoided by changing the order of steps and forming the first solid electrolyte layer 101 and the second solid electrolyte layer 102 after bonding thereof.

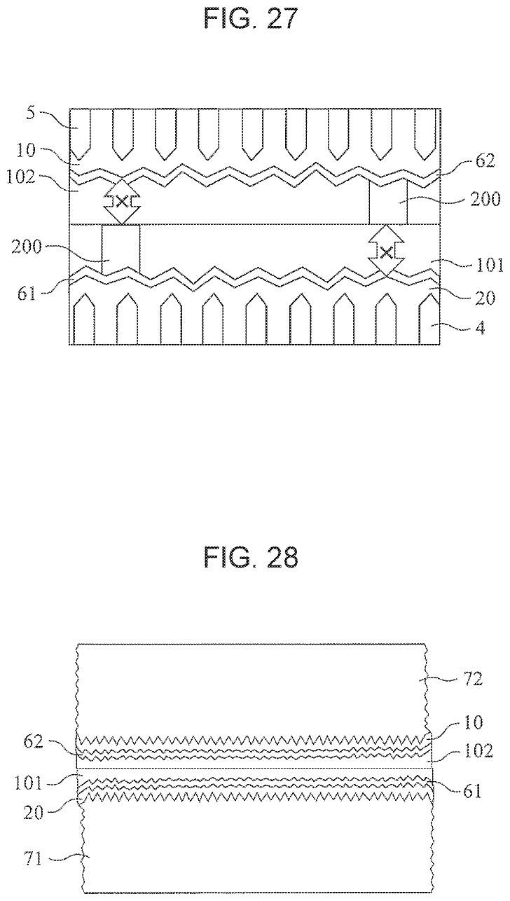

FIG. 27 illustrates a shape of the fuel battery cell 1 according to Embodiment 2 at the portions where the foreign matters 200 on the lower electrode layer 20 and the upper electrode layer 10 are present. At the portions where the foreign matters 200 are present, the upper portions of the foreign matters are also removed and flattened by the CMP process for the first solid electrolyte layer 101 and the CMP process for the second solid electrolyte layer. The thickness of each of the first solid electrolyte layer 101 and the second solid electrolyte layer 102 is a thickness at which the leakage current can be independently limited. A probability that a position of the foreign matter in the first solid electrolyte layer 101 and a position of the foreign matter in the second solid electrolyte layer 102 overlap each other at the time of bonding in FIG. 25 is sufficiently low, and thus the defective rate due to the leakage current between the anode and the cathode via the foreign matters is sufficiently reduced in the fuel battery cell 1 according to Embodiment 2. In the fuel battery cell according to Embodiment 2 as well, the leakage current generated at the foreign matter portions can be limited, and a high non-defective rate can be secured even in the cell area larger than the minimum cell area that is allowed from the viewpoint of cost.

In other words, Embodiment 2 may be configured as follows. Similarly to Embodiment 1, the thickness of the second solid electrolyte layer 102 in Embodiment 2 is ensured to such an extent that the leakage current between the first solid electrolyte layer 101 and the second solid electrolyte layer 102 can be blocked at any location even when the output voltage of the fuel battery cell 1 is generated between the lower electrode layer 20 and the upper electrode layer 10. Further, in Embodiment 2, the thickness of the first solid electrolyte layer 101 is also secured to such an extent that the leakage current between the first solid electrolyte layer 101 and the second solid electrolyte layer 102 can be similarly blocked at any location (that is, at a location being thinnest in thickness).

### Embodiment 2: Modification

FIG. 28 illustrates a modification of Embodiment 2. Although the first AAO substrate 4 and the second AAO substrate 5 are used in FIGS. 20 to 26, the first porous metal substrate 71 and a second porous metal substrate 72 can also be used as in the modification of Embodiment 2 illustrated in FIG. 28.

A component obtained by removing and flattening a part of the upper portion of the first solid electrolyte layer 101 by CMP after the lower electrode layer 20, the first interface layer 61, and the first solid electrolyte layer 101 are formed on the first porous metal substrate 71, and a component obtained by removing and flattening a part of an upper portion of the second solid electrolyte layer 102 by CMP after the upper electrode layer 10, the second interface layer 62, and the second solid electrolyte layer 102 are formed on the second porous metal substrate 72, are bonded to complete the fuel battery cell 1 by being brought into contact with each other and being fired at the surface of the first solid electrolyte layer 101 and the surface of the second solid electrolyte layer 102. The residual thickness of the first solid electrolyte layer 101 in the CMP process is required to be equal to or larger than the unevenness (D) of the predetermined region on the surface of the lower electrode layer 20 serving as a base, and is required to be a thickness at which the leakage current is stopped by only the thickness of the first solid electrolyte layer 101. The thickness of the thinnest region may be 100 nm or more. The residual thickness of the second solid electrolyte layer 102 in the CMP process is required to be equal to or larger than the unevenness (D) of the predetermined region on the surface of the upper electrode layer 10 serving as a base, and is required to be a thickness at which the leakage current is stopped by only the thickness of the second solid electrolyte layer 102. The thickness of the thinnest region may be 100 nm or more.

Since the second solid electrolyte layer 102 is formed by being flattened by CMP after being formed on the upper surface of the upper electrode layer 10, the thickness thereof is irrelevant to the unevenness of the surface of the upper electrode layer 10. On the other hand, since the first solid electrolyte layer 101 is formed by being flattened by CMP after being formed on the upper surface of the lower electrode layer 20, the thickness thereof is irrelevant to the unevenness of the surface of the lower electrode layer 20.

In the structure in FIG. 26, the first AAO substrate 4 and the second AAO substrate 5 are insulators, and thus it is necessary to form the lower electrode wiring layer 21 and the upper electrode wiring layer 11. However, in the structure of the modification in FIG. 28, the first porous metal substrate 71 and the second porous metal substrate 72 are formed of a conductive metal, and thus it is easy to supply power to the lower electrode layer 20 and the upper electrode layer 10. Since the first porous metal substrate 71 and the second porous metal substrate 72 are porous, the fuel gas or the oxidant gas can be supplied to the lower electrode layer 20 and the upper electrode layer 10 through the first porous metal substrate 71 and the second porous metal substrate 72, respectively.

The thickness of each of the first solid electrolyte layer 101 and the second solid electrolyte layer 102 is a thickness at which the leakage current can be independently limited, and the probability that the position of the foreign matter in the first solid electrolyte layer 101 and the position of the foreign matter in the second solid electrolyte layer 102 overlap each other at the time of bond in FIG. 28 is sufficiently low, and thus the defective rate due to the leakage current between the anode and the cathode via the foreign matters is sufficiently reduced in the fuel battery cell 1 according to the modification of Embodiment 2. In the fuel battery cell according to the modification of Embodiment 2 as well, the leakage current generated at the foreign matter portions can be limited, and a high non-defective rate can be secured even in the cell area larger than the minimum cell area that is allowed from the viewpoint of cost.

### <Modification of Invention>

The invention is not limited to the above embodiments, and includes various modifications. For example, the above embodiments are described in detail for easy understanding of the invention, and the invention is not necessarily limited to those including all the configurations described above. Further, a part of a configuration according to one embodiment can be replaced with a configuration according to another embodiment, and the configuration according to another embodiment can be added to the configuration according to one embodiment. In addition, a part of the configuration of each of the embodiments may be added to, deleted from, or replaced with another configuration.

In the above embodiments, the lower electrode layer 20 may function as an anode layer and the upper electrode layer 10 may function as a cathode layer, and the upper electrode layer 10 may function as an anode layer and the lower electrode layer 20 may function as a cathode layer. In any of these cases, the effects of the invention can be obtained.

### REFERENCE SIGNS LIST

1 fuel battery cell
2 silicon substrate
3 silicon substrate
4 first anodized alumina substrate (AAO substrate)
5 second anodized alumina substrate (AAO substrate)
10 upper electrode layer
11 upper electrode wiring layer
20 lower electrode layer
21 lower electrode wiring layer
51 first pore
52 second pore
61 first interface layer
62 second interface layer
71 first porous metal substrate
72 second porous metal substrate
101 first solid electrolyte layer
102 second solid electrolyte layer
200 foreign matter
301 first fuel battery cell end portion
302 second fuel battery cell end portion

1. A fuel battery cell comprising:
a first porous substrate;
a first porous electrode layer formed on the first porous substrate;
a first solid electrolyte layer formed on the first porous electrode layer;
a second solid electrolyte layer formed to be directly in contact with the first solid electrolyte layer; and
a second porous electrode layer formed on a side of the second solid electrolyte layer that is not in contact with the first solid electrolyte layer, wherein
an interface between the first solid electrolyte layer and the second solid electrolyte layer is flatter than an interface between the first solid electrolyte layer and the first porous electrode layer, and
even when an output voltage of the fuel battery cell is generated between the first porous electrode layer and the second porous electrode layer, a portion of the second solid electrolyte layer, which is thinnest in thickness, has a thickness at which a leakage current between the first solid electrolyte layer and the second solid electrolyte layer is less than an allowable value.

2. The fuel battery cell according to claim 1, wherein
a difference between a maximum thickness and a minimum thickness of the second solid electrolyte layer is smaller than a total of a maximum peak height and a maximum valley depth on a surface of the first porous electrode layer.

3. The fuel battery cell according to claim 1, wherein
a thickness of the first solid electrolyte layer is equal to or larger than a total of a maximum peak height and a maximum valley depth on a surface of the first porous electrode layer, and is not more than twice the total, and
a total of the thickness of the first solid electrolyte layer and a thickness of the second solid electrolyte layer is equal to or less than 1 micrometer.

4. The fuel battery cell according to claim 1, further comprising at least one of:
a first interface layer disposed on the interface between the first solid electrolyte layer and the first porous electrode layer, and thrilled of a metal oxide different from a material for the first solid electrolyte layer, and
a second interface layer disposed on an interface between the second solid electrolyte layer and the second porous electrode layer, and formed of a metal oxide different from a material for the second solid electrolyte layer.

5. The fuel battery cell according to claim 1, wherein
the first porous substrate has a first hole having a depth in contact with the first porous electrode layer, and
a first wiring layer for supplying power to the first porous electrode layer is formed on an inner wall of the first hole.

6. The fuel battery cell according to claim 1, further comprising:
a second porous substrate formed on the second porous electrode layer, wherein
the second porous substrate has a second hole having a depth in contact with the second porous electrode layer,
a second wiring layer for supplying power to the second porous electrode layer is formed on an inner wall of the second hole,
the interface between the first solid electrolyte layer and the second solid electrolyte layer is flatter than an interface between the second solid electrolyte layer and the second porous electrode layer, and
even when the output voltage of the fuel battery cell is applied between the first porous electrode layer and the second porous electrode layer, a portion of the first solid electrolyte layer, which is thinnest in thickness, has a thickness at which the leakage current between the first solid electrolyte layer and the second solid electrolyte layer is less than an allowable value.

7. The fuel battery cell according to claim 1, wherein
the first porous substrate is an anodized alumina substrate or a porous metal substrate.

8. A manufacturing method for a fuel battery cell, comprising:
a step of forming a first porous electrode layer on a first porous substrate;
a step of forming a first solid electrolyte layer on the first porous electrode layer;
a step of flattening a surface of the first solid electrolyte layer;
a step of forming a second solid electrolyte layer to be directly in contact with the flattened surface of the first solid electrolyte layer; and
a step of forming a second porous electrode layer on a surface of the second solid electrolyte layer that is not in contact with the first solid electrolyte layer, wherein
an interface between the first solid electrolyte layer and the second solid electrolyte layer is flatter than an interface between the first solid electrolyte layer and the first porous electrode layer, and
even when an output voltage of the fuel battery cell is generated between the first porous electrode layer and the second porous electrode layer, a portion of the second solid electrolyte layer, which is thinnest in thickness, has a thickness at which a leakage current between the first solid electrolyte layer and the second solid electrolyte layer is less than an allowable value.

9. The manufacturing method for a fuel battery cell according to claim 8, wherein
a difference between a maximum thickness and a minimum thickness of the second solid electrolyte layer is smaller than a total of a maximum peak height and a maximum valley depth on a surface of the first porous electrode layer.

10. The manufacturing method for a fuel battery cell according to claim 8, wherein
a thickness of the first solid electrolyte layer is equal to or larger than a total of a maximum peak height and a maximum valley depth on a surface of the first porous electrode layer, and is not more than twice the total, and
a total of the thickness of the first solid electrolyte layer and a thickness of the second solid electrolyte layer is equal to or less than 1 micrometer.

11. The manufacturing method for a fuel battery cell according to claim 8, further comprising at least one of:
a step of forming a first interface layer that is disposed on the interface between the first solid electrolyte layer and the first porous electrode layer, and is formed of a metal oxide different from the first solid electrolyte layer, between the step of forming the first solid electrolyte layer and the step of forming the first porous electrode layer, and
a step of forming a second interface layer that is disposed on an interface between the second solid electrolyte layer and the second porous electrode layer, and is formed of a metal oxide different from the second solid electrolyte layer, between the step of forming the second solid electrolyte layer and the step of forming the second porous electrode layer.

12. The manufacturing method for a fuel battery cell according to claim 8, wherein
the first porous substrate has a first hole having a depth in contact with the first porous electrode layer, and
the method further comprises:
a step of providing the first porous substrate on a first flat substrate before the step of forming the first porous electrode layer;
a step of forming a void having a depth in contact with the first porous substrate by removing a part of a surface on a side of the first flat substrate that is not in contact with the first porous substrate; and
a step of forming, on an inner wall of the first hole, a first wiring layer for supplying power to the first porous electrode layer.

13. The manufacturing method for a fuel battery cell according to claim 8, wherein
the step of forming the second solid electrolyte layer and the step of forming the second porous electrode layer include
a step of forming the second porous electrode layer on a second porous substrate,
a step of forming the second solid electrolyte layer on the second porous electrode layer,
a step of flattening a surface of the second solid electrolyte layer, and
a step of bonding the flattened surface of the second solid electrolyte layer onto the flattened surface of the first solid electrolyte layer.

14. The manufacturing method for a fuel battery cell according to claim 13, wherein
the second porous substrate has a second hole having a depth in contact with the second porous electrode layer, and
the method further comprises:
a step of providing the second porous substrate on a second flat substrate before the step of forming the second porous electrode layer;
a step of forming a void having a depth in contact with the second porous substrate by removing a part of a surface on a side of the second flat substrate that is not in contact with the second porous substrate; and
a step of forming, on an inner wall of the second hole, a second wiring layer for supplying power to the second porous electrode layer,
the interface between the first solid electrolyte layer and the second solid electrolyte layer is flatter than an interface between the second solid electrolyte layer and the second porous electrode layer, and
even when the output voltage of the fuel battery cell is applied between the first porous electrode layer and the second porous electrode layer, a portion of the first solid electrolyte layer, which is thinnest in thickness, has a thickness at which the leakage current between the first solid electrolyte layer and the second solid electrolyte layer is less than an allowable value.

15. The manufacturing method for a fuel battery cell according to claim 8, wherein
the first porous substrate is an anodized alumina substrate or a porous metal substrate.
